(19) United States
(12) Patent Application Publication
(10) Pub. No.: US 2015/0312317 A1
(43) Pub. Date: Oct. 29, 2015

(54) VEHICLE PROXY LIFECYCLE MANAGEMENT

(71) Applicant: Ford Global Technologies, LLC, Dearborn, MI (US)

(72) Inventors: Edward WEHRMAN, Leesburg, VA (US); Elizabeth HALASH, Dearborn, MI (US); Stefan BANKOWSKI, Royal Oak, MI (US); Nicholas THORNE, Dearborn, MI (US); Kevin BURDETTE, Plymouth, MI (US)

(73) Assignee: Ford Global Technologies, LLC, Dearborn, MI (US)

(21) Appl. No.: 14/264,733

(22) Filed: Apr. 29, 2014

(51) Int. Cl. H04L 29/08; G06F 3/0482; G06F 3/0484

(52) U.S. Cl. CPC H04L 67/025; G06F 3/04842; G06F 3/0482; H04L 67/125

(57) ABSTRACT

A device may register a mobile application with a vehicle-based computing system (VCS) using an application proxy configured to manage nomadic device connection to the VCS, and utilize the application proxy, by the mobile application, to present a mobile application user interface via a human-machine interface (HMI) of the VCS in accordance with an HMI status received from the VCS and indicative of a level of mobile application HMI access.

### TECHNICAL FIELD

This disclosure generally relates to connection lifecycle management for networked applications using an application proxy.

### BACKGROUND

In-vehicle telematics systems may include communications and entertainment features that allow drivers to make and receive hands-free telephone calls, control music, and have turn-by-turn directions. These systems may further allow for control of such features via voice commands. To support various telematics features of the vehicle, a mobile device may be paired with the telematics system and used to provide the system with access to functions of the mobile device.

### SUMMARY

In a first illustrative embodiment, a system includes a nomadic device configured to register a mobile application with a vehicle-based computing system (VCS) using an application proxy configured to manage a nomadic device connection to the VCS, and utilize the application proxy, by the mobile application, to present a mobile application user interface, via a human-machine interface (HMI) of the VCS, according to an HMI status received from the VCS and indicative of a level of mobile application HMI access.

In a second illustrative embodiment, a system includes a vehicle-based computing system (VCS) configured to receive a registration of a proxy listener of a mobile from a nomadic device application proxy; send an HMI status to the proxy listener indicative of a level of mobile application HMI access to be provided to the mobile application; and present a mobile application user interface, via a VCS human-machine interface (HMI), in accordance with the HMI status.

In a third illustrative embodiment, a non-transitory computer-readable medium including instructions that, when executed by a processor of a nomadic device, are configured to cause the nomadic device to register a mobile application with a vehicle-based computing system (VCS) using an application proxy configured to manage nomadic device connection to the VCS, and utilize the application proxy, by the mobile application, to present a mobile application user interface via a human-machine interface (HMI) of the VCS in accordance with an HMI status received from the VCS and indicative of a level of mobile application HMI access.

### BRIEF DESCRIPTION OF THE DRAWINGS

FIG. 1 illustrates an exemplary block topology of a vehicle infotainment system implementing a user-interactive vehicle based computing system;

FIG. 2 illustrates an exemplary vehicle in communication with a nomadic device via an application proxy; and

FIG. 3 illustrates an exemplary process for providing automated lifecycle management of the connection between the vehicle infotainment system and the mobile application.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A mobile application may refer to a software executable that is stored on and executed by a mobile device, such as a cell phone. A vehicle-based computing system (VCS) may include mobile gateway functionality to allow such mobile applications to present a human-machine interface (HMI) through a user interface of the vehicle, in a safe, non-distracting and consistent way. Thus, while the mobile application may be executed by the mobile device, the application may utilize the mobile gateway to exchange program data as well as command and control information with the VCS.

To facilitate the exchange of data and information between the VCS and the mobile device, the mobile device may host an application proxy intermediary that sits between the mobile application and the mobile gateway of the VCS. While the application proxy may facilitate communication between the mobile application and the VCS, the application proxy may require each mobile application to manually create and maintain the proxy object, as well as handle connection, handshaking, disconnection and various error scenarios.

An improved application proxy may be configured to automatically manage the lifecycle of the connection to the VCS on behalf of the mobile application. The improved application proxy may be configured to handle handshaking, connection management, and other aspects of the lifecycle of the connection between the VCS and the mobile device. By using the improved application proxy, the mobile application may be able to simplify its handling of the proxy and associated VCS connection, as well as ensure that mobile applications properly handle needed setup, timing and maintenance operations required for connection and communication with the VCS.

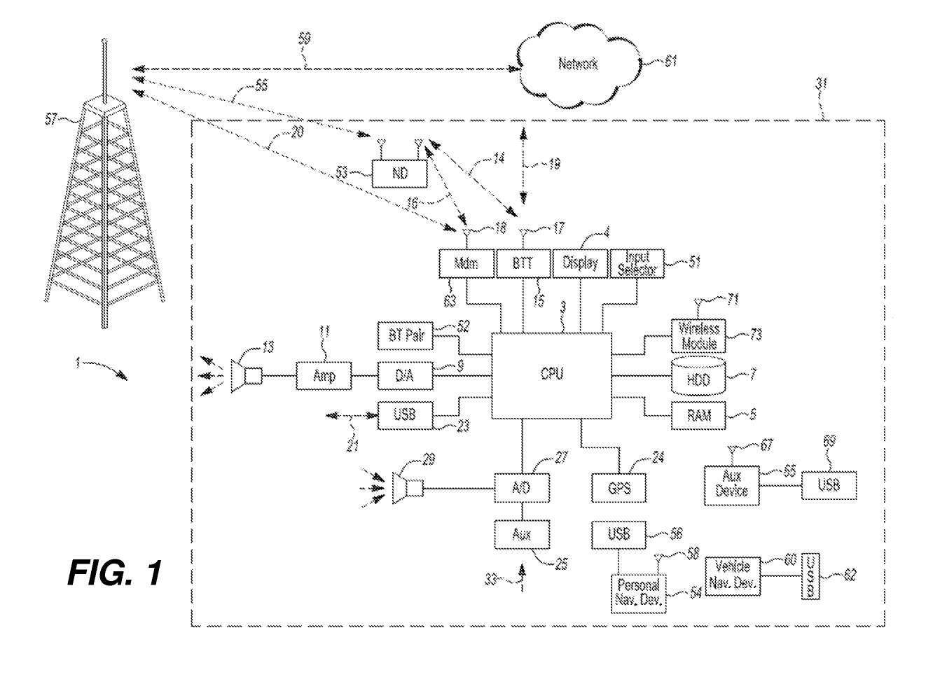

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

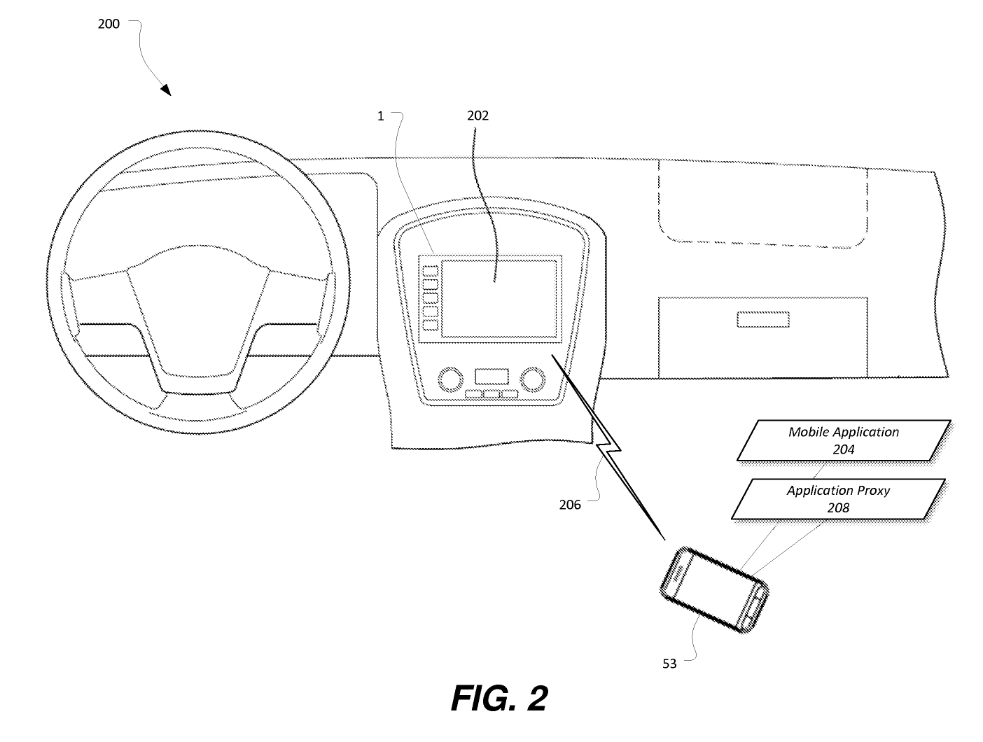

FIG. 2 illustrates an exemplary vehicle 31 in communication with a nomadic device 53 via an application proxy 208. As mentioned above, the CPU 3 of the VCS 1 may be configured to interface with one or more nomadic devices 53. To facilitate the interfacing, the VCS 1 may include mobile gateway functionality configured to provide vehicle 31 services to the nomadic device 53 connected to the VCS 1 over a connection 206. A mobile application 204 installed on the nomadic device 53 may instantiate the application proxy 208 to allow the mobile application 204 to utilize the connection 206 to register with the VCS 1 and take advantage of the HMI 202 and other services provided by the VCS 1.

The HMI 202 of the vehicle 31 may refer to the interface that the user (e.g., the driver) uses to interact with the vehicle 31. The HMI 202 interface may include various types of inputs and outputs facilitating communication between the user and the VCS 1. As some examples, the HMI 202 may include the display 4 or other displays of the vehicle 31, a collection of preset buttons, media buttons (seek forward/backward, tune up/down, and play/pause), other application or system associated menu items, and application or system assigned voice commands.

The mobile application 204 may be configured to be executed by the nomadic device 53, and to interact with the user via the HMI 202 of the vehicle 31. As one example, a music player application 204 on the nomadic device 53 may interact with the VCS 1 to provide streaming music through the speaker 13 or stereo system output of the VCS 1. As another example, a navigation application 204 on the nomadic device 53 may interact with the VCS 1 to provide turn-by-turn directions for display on the screen 4 of the VCS 1.

To utilize the HMI 202, the mobile application 204 may be configured to communicate with the VCS 1 over a connection 206 between the VCS 1 and the nomadic device 53. The connection 206 may include various wired and wireless data connections between the VCS 1 and the nomadic device 53 over which mobile application 204 data may be transmitted. As one example, the connection 206 may include a BLUETOOTH connection 206 between the BLUETOOTH transceiver 15 of the VCS 1 and a BLUETOOTH module of the nomadic device 53. Additionally or alternately, the connection 206 may include a USB connection 206 between the USB input 23 to the VCS 1 and a USB connection to the nomadic device 53.

To facilitate the exchange of data and information between the VCS 1 and the application proxy 208, the nomadic devices 53 may host an application proxy 208 intermediary configured to manage the connection 206 between the mobile gateway of the VCS 1 and the mobile applications 204 of the nomadic device 53. The application proxy 208 may be configured to handle automated lifecycle management of the connection 206, such as handshaking, connection management, and other aspects of the connection 206 between the VCS 1 and the nomadic device 53.

The mobile application 204 may utilize the automated lifecycle management functionality of the application proxy 208 by instantiating an application proxy 208 object. Once instantiated, the application proxy 208 may be configured to manage the lifecycle of the VCS 1 connection 206 on behalf of the mobile application 204. Thus, rather than being required to perform all of the handshaking and connection management tasks itself, the mobile application 204 may instead implement a callback interface to the application proxy 208 to allow the mobile application 204 to monitor and respond to events related to the connection 206.

In an example, the application proxy 208 object may be configured to expose one or more constructors for instantiation. Through use of the object constructor, the mobile application 204 may pass information to the application proxy 208 that the application proxy 208 may use to register an interface with the VCS 1 on behalf of the mobile application 204. For instance, when building an application proxy 208 instance through a constructor, the mobile application 204 may provide a name of the mobile application 204, an indication of whether the mobile application 204 is a media mobile application 204, and an implementation of the application proxy 208 listener callback interface. The application proxy 208 listener callback interface, sometimes referred to as the proxy listener of the mobile application 204, may be configured to be the object that receives callbacks when the VCS 1 sends responses and notifications to the mobile application 204.

The proxy listener may include a remote procedure call notification function called by the VCS 1 to convey information regarding the state of the vehicle 31 HMI 202. This notification function may be utilized by the mobile application 204 to determine an HMI level of the mobile application 204 (i.e., whether the mobile application 204 is actively displaying information to the driver) and an audio streaming state (i.e., whether the mobile application 204 can stream audio to the driver). This information may then be used by the mobile application 204 to allow it to determine which remote procedure calls may be called via the application proxy 208 (e.g., what aspects of the vehicle 31 HMI 202 are currently allowed to be utilized by the mobile application 204).

The HMI levels may include, for example, a “FULL” level, a “LIMITED” level, a “BACKGROUND” level, and a “NONE” level. In the “FULL” level, the mobile application 204 may be given full access to the HMI 202 of the VCS 1. The mobile application 204 may receive an HMI level notification of “FULL” from the proxy listener when the mobile application 204 is moved into focus, such as when the user selects the mobile application 204 from a menu of the HMI 202 listing available mobile applications, or when the VCS 1 turns its attention back to mobile application (e.g., after completion of a phone call via the vehicle 31 HMI 202 that had temporarily interrupted use of the mobile application 204).

In the “LIMITED” level, the mobile application 204 may be given partial access to the HMI 202 of the VCS 1. The mobile application 204 may receive an HMI level notification of “LIMITED” from the proxy listener when the mobile application 204 is able to perform certain functions, but when another feature requiring partial HMI access 202 such as navigation is presently active.

In the “BACKGROUND” level, the mobile application 204 may no longer be the currently in focus application of the HMI 202 of the VCS 1, but may still be active as a secondary process. The mobile application 204 may receive an HMI level notification of “BACKGROUND” from the proxy listener due to another mobile application 204 or other VCS 1 application opening as the in-focus or foreground application, or responsive to a user-initiated event such as the user switching the currently active application 204. When in the “BACKGROUND” level, since another application is in the foreground, the user may not be able to directly interact with the mobile application 204 (e.g., push-to-talk (PTT) initiated voice commands and application-specific menu commands may be unavailable), and the mobile application 204 may be unable to directly interact with the user via the vehicle 31 HMI 202.

In the “NONE” level, the mobile application 204 may have registered its user interface, but may be unable to perform any actions via the VCS 1. Notably, an operation which is started (but not yet terminated) by a mobile application 204 while that mobile application 204 has an HMI Level of “FULL” or “LIMITED,” may automatically be terminated when that application 204 loses focus on the HMI 202 due to a transition to the “BACKGROUND” or “NONE” levels (e.g., cancellation of an in-progress interaction or PTT speech recognition scenario, etc.).

With respect to the audio streaming state, the HMI status notifications may also be configured to inform the mobile application 204 that there has been a chance in the ability of the mobile application 204 to stream audio over the audio bus of the vehicle 31. These audio streaming states may include, for example, an “AUDIBLE” state in which currently streaming audio from the application 204, if any, is audible to the user through VCS 1, and a “NOT AUDIBLE” state in which currently streaming audio from the application 204, if any, is not audible to the user through VCS 1.

When the VCS 1 and the nomadic device 53 are connected via the connection 206 (and the indicated HMI level provides for communication), the application proxy 208 may be configured to provide transport for mobile application 204 messaging with the VCS 1. These messages may include (but are not limited to) command and control information, as well as other program data. To implement the messaging, the application proxy 208 may support techniques such as remote procedure calls and callbacks (e.g., via the proxy listener) to provide the various types of communication between the mobile application 204 and the VCS 1. As some examples, the mobile application 204 may utilize the application proxy 208 to communicate with the VCS 1 over the connection 206 to perform actions such as: display text or other user interface content on the VCS 1 HMI, receive command input from the user of the VCS 1 (e.g., indications of spoken voice commands via PTT, indications of button presses or touch input to the vehicle 31 HMI 202), and send or receive information indicative of completion of asynchronous operations.

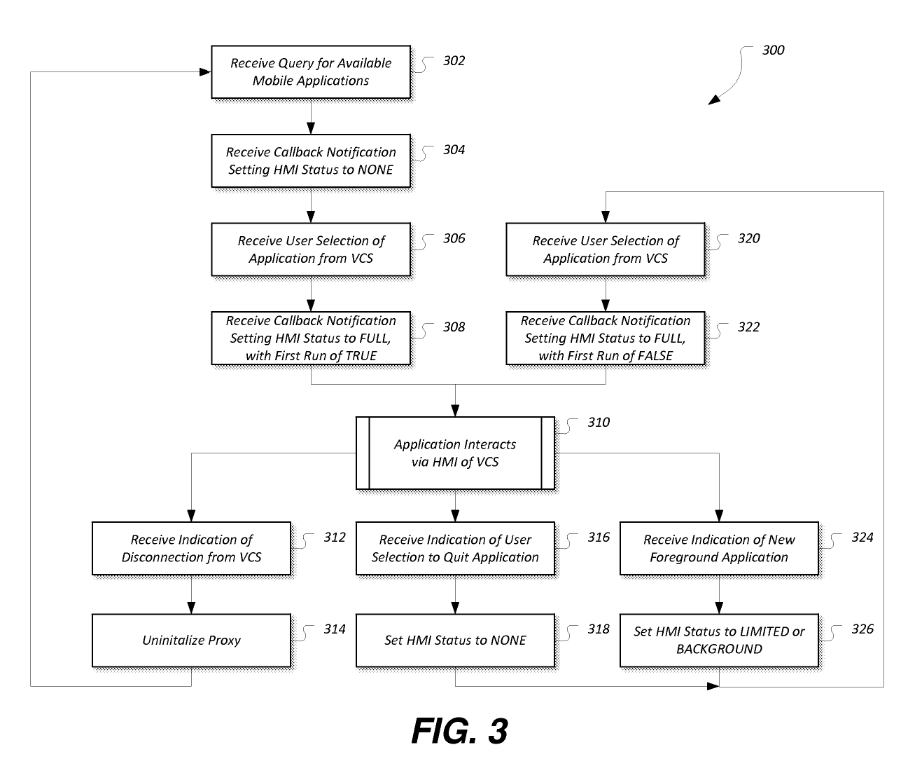

The mobile application 204 may be configured to maintain the application proxy 208 object so long as the connection 206 is required by the mobile application 204. For instance, the mobile application 204 may be configured to dispose of and discard the application proxy 208 when the mobile application 204 no longer requires further communication with the VCS 1, or when the mobile application 204 identifies that an unrecoverable error has occurred. Otherwise, the mobile application 204 may be configured to retain the application proxy 208 object to manage whatever connections to and subsequent disconnections from the VCS 1 may occur for the duration of its lifecycle of the application proxy 208. Further aspects of the lifecycle management performed by the application proxy 208 are discussed in further detail below with respect to FIG. 3.

FIG. 3 illustrates an exemplary process 300 for providing automated lifecycle management of the connection 206 between the VCS 1 and the mobile application 204. The process 300 may be performed by the application proxy 208 object and mobile application 204 executed by one or more processors of the nomadic device 53, and in communication with the VCS 1 of the vehicle 31. At the outset of the process 300, the mobile application 204 may be configured to instantiate the application proxy 208 object before the nomadic device 53 connects to the VCS 1, such as by creating the application proxy 208 in the background on device boot.

At block 302, the nomadic device 53 receives a VCS 1 query for available mobile applications 204. For example, the VCS 1 may perform a service discovery protocol (SDP) inquiry against the currently connected nomadic device 53, to query for endpoints having a specific service class universally unique identifier (UUID) associated with those mobile applications 204 that are compatible with connection to the VCS 1. The application proxy 208 of the nomadic device 53 may respond to the VCS 1 with a listing of the mobile applications 204, and may receive in response radio frequency communications (RFCOMM) open connection requests to those discovered endpoints. If the mobile application 204 accepts the connection request, the mobile application 204 may be required to call a registration function of the VCS 1 within a predetermined amount of time upon receiving the request (e.g., within 20 seconds). The mobile applications 204 that are successfully registered with the VCS 1 may then appear in a mobile applications menu or other HMI of the VCS 1 for selection by the user. Notably, creating the application proxy 208 instance enables the mobile application 204 to be found and invoked by the VCS 1, but its creation does not indicate that the mobile application 204 is immediately connected to the VCS 1.

At block 304, the mobile application 204 receives a callback notification from the VCS 1 setting the HMI status to the “NONE” level. For example, the VCS 1 may send the HMI status callback message indicating the HMI status of “NONE” over the connection 206, after successful registration of the proxy listener of the mobile application 204 with the VCS 1. The mobile application 204 may accordingly receive the “NONE” level callback notification via the application proxy 208. When at the “NONE” HMI status level, the mobile application 204 may be available for use from the mobile applications 204 menu of the VCS 1; however, the mobile application 204 may not issue requests (i.e. consume system resources) because the user is unaware of the existence of the application 204 and has not selected that the application 204 be invoked (e.g., via the mobile applications menu).

At block 306, the VCS 1 receives a user selection of the mobile application 204. For example, the user may select to run the mobile application 204 from the mobile applications menu. Upon receiving that indication from the user, the VCS 1 may determine the user as having opted-in to use of the mobile application 204, and may grant the mobile application 204 access to system resources (e.g., requests may now be issued by the mobile application 204 to the VCS 1). Accordingly, the VCS 1 may initiate the initial connection to the mobile application 204 in response to user interaction in the vehicle 31.

At block 308, the mobile application 204 receives a callback notification from the VCS 1 setting the HMI status to “FULL.” When the mobile application 204 receives the HMI status notification of the “FULL,” the mobile application 204 may begin sending requests to the VCS 1. Moreover, when initializing the mobile application 204, the mobile application 204 may be configured to perform certain initial tasks, such as register voice commands to be recognized by the HMI 202 of the VCS 1, subscribe to receive input from buttons of the HMI 202, set up help prompts to explain functions of the mobile application 204, etc. These tasks may only be required to be performed when the mobile application 204 is first started or first brought forward as the in-focus application 204, but not for example, when the mobile application 204 regains focus or regains foreground status on the VCS 1. To handle the initialization, the mobile application 204 may accordingly maintain a first run setting (e.g., as a Boolean variable initialized to true) and may execute the initialization code on the first time that the mobile application 204 receives a notification of setting the HMI status to “FULL,” and further adjust the first run setting (e.g., to false).

At block 310, the mobile application 204 interacts with the VCS 1 over the connection 206. For example, the mobile application 204 may utilize the application proxy 208 to access the HMI 202 of the VCS 1 to perform application functions, such as display text to the user, receive input such as voice commands and button presses, and provide audio output to the user. Thus, while the mobile application 204 may be executed by the nomadic device 53, the mobile application 204 may utilize the application proxy 208 to exchange program data as well as command and control information with the VCS 1. The mobile application 204 may continue to interact with the VCS 1 until one or more possible events occur, such as upon a request by the mobile application 204 to disconnect from the VCS 1, another application replacing the mobile application 204 as the foreground application, or the user explicitly providing an exit action to the mobile application 204.

At block 312, the mobile application 204 disconnects from the VCS 1. There are various ways that a mobile application 204 may be disconnected from the VCS 1. For example, the mobile application 204 may request that the application proxy 208 reset the proxy and disconnect from the VCS 1. As another example, the mobile application 204 may call a dispose method of the application proxy 208. As yet a further example, the connection 206 between the VCS 1 and the mobile application 204 may be expectedly or unexpectedly lost (e.g. the nomadic device 53 and the vehicle 31 are out of range of each other, etc.). As an even further example, the application proxy 208 may encounter an unrecoverable error which cannot be resolved without intervention by the mobile application 204.

At block 314, the mobile application 204 receives a notification via a proxy closed callback of the proxy listener indicating to the mobile application 204 that the mobile application 204 is disconnected. For example, responsive to the request that the application proxy 208 reset the proxy and disconnect from the VCS 1, the application proxy 208 may accordingly disconnect from any existing connection 206 with the VCS 1, dispose of all transient resources related to the connection 206 and reinitialize itself. Once the re-initialization has completed, the application proxy 208 may be configured to accept new connections 206 from the VCS 1.

As another example, responsive to the mobile application 204 call to the dispose method of the application proxy 208, the application proxy 208 may permanently disconnect from any existing connections 206 with the VCS 1 and dispose of all resources. At this point, the application proxy 208 object may be discarded. A new application proxy 208 object will need to be instantiated before further communication with the VCS 1 may occur.

As yet a further example, responsive to the connection 206 between the VCS 1 and the mobile application 204 being lost, the mobile application 204 may be notified via a proxy closed callback of the proxy listener, and may continue to monitor for new VCS 1 connections 206.

As an even further example, responsive to the application proxy 208 encountering an unrecoverable error which cannot be resolved without intervention by the mobile application 204, the mobile application 204 may similarly be notified via the proxy closed callback. At this point, the application proxy 208 object should be disposed of and discarded, and a new application proxy 208 object should be instantiated to resume communication with the VCS 1.

After block 314, control passes to block 302 to perform re-initialization of the application proxy 208.

At block 316, the mobile application 204 receives an indication of an exit or quit HMI action. For example, the user may select “Exit <app_name>” (where app_name is identified by the VCS 1 according to the registration of the mobile application 204 with the VCS 1) via a menu of the HMI 202 or may speak a push-to-talk command requesting to exit the mobile application 204. By this action, the user may have opted out of using the mobile application 204.

At block 318, the nomadic device 53 receives a callback notification from the VCS 1 setting the HMI status to “NONE.” Thus, the mobile application 204 may no longer send requests to the VCS 1 via the connection 206. However, the registration of the mobile application 204 with the VCS 1 (e.g, button subscriptions, display state, custom prompts, interaction Choice Sets, and commands) may be persisted by the VCS 1 for later use.

At block 320, and similar to as discussed above with respect to block 306, the VCS 1 again receives a user selection of the mobile application 204. For example, the user may again select to run the mobile application 204 from the mobile applications menu. Upon receiving that indication from the user, the VCS 1 may determine the user as having once again opted-in to use of the mobile application 204.

At block 322, and similar to as discussed above with respect to block 308, the nomadic device 53 receives a callback notification from the VCS 1 setting the HMI status to “FULL.” When the mobile application 204 receives the HMI status notification of the “FULL”, the mobile application 204 may begin sending requests to the VCS 1. As the registration of the mobile application 204 with the VCS 1 may be persisted by the VCS 1, the first run setup may not be required to be performed. For instance, the mobile application 204 may accordingly determine according to the first run setting that execution of the initialization code is not required. After block 322, control returns to block 310.

At block 324, the mobile application 204 receives an indication of another application becoming the foreground application of the VCS 1. For example, the user may select another mobile application 204 from the mobile applications menu of the HMI 202 or may speak a push-to-talk command requesting to invoke another mobile application 204.

At block 326, the nomadic device 53 receives a callback notification from the VCS 1 setting the HMI status to “LIMITED” or “BACKGROUND.” In the “LIMITED” level, the mobile application 204 may be given partial access to the HMI 202 of the VCS 1, such as when a navigation feature of the VCS 1 is the other application made active. In the “BACKGROUND” level, the mobile application 204 may no longer be the currently in focus application of the HMI 202 of the VCS 1, but may still be active as a secondary process. As a secondary process, the mobile application 204 may have access to a subset of HMI 202 features, such as access to streaming audio functions but not to the display 4. After block 326, if the VCS 1 receives a user selection of the mobile application 204, control passes to block 320.

Thus, by using the application proxy 208, the mobile application 204 may be able to simplify its handling of the connection 206 to and HMI 202 of the VCS 1, as well as ensure that the application proxy 208 handles for the mobile applications 204 the needed setup, timing and maintenance operations required for the connection 206 to the VCS 1. By utilizing the callback notifications of HMI status provided to the mobile application 204 by the application proxy 208, the mobile application 204 may accordingly be executed by the nomadic device 53 but present a user interface through the vehicle 31 HMI 202, in a safe, non-distracting and consistent way.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a nomadic device configured to
register a mobile application with a vehicle-based computing system (VCS) using an application proxy configured to manage a nomadic device connection to the VCS, and
utilize the application proxy, by the mobile application, to present a mobile application user interface, via a human-machine interface (HMI) of the VCS, according to an HMI status received from the VCS and indicative of a level of mobile application HMI access.

2. The system of claim 1, wherein the nomadic device is further configured to receive the HMI status from the VCS responsive to the mobile application being moved into a foreground of the HMI of the VCS, and wherein the HMI status indicates that the mobile application is given full access to the HMI.

3. The system of claim 2, wherein the nomadic device is further configured to perform user interface initialization with the VCS when the mobile application determines that the mobile application has not previously received an HMI status of full access to the HMI.

4. The system of claim 1, wherein the nomadic device is further configured to receive the HMI status by the application proxy, via the connection, to a proxy listener of the mobile application.

5. The system of claim 4, wherein the HMI status is received by the proxy listener responsive to user selection of the mobile application from a mobile applications menu of the VCS.

6. The system of claim 4, wherein the nomadic device is further configured to un-initialize mobile application use of the application proxy responsive to receipt of a notification via a proxy closed callback of the proxy listener indicating to the mobile application that the application proxy is disconnected from the VCS.

7. The system of claim 1, wherein the nomadic device is further configured to:
instantiate the application proxy as a background process of the nomadic device;
receive, from the VCS by the application proxy, a query for mobile applications available on the nomadic device; and
respond to the VCS by the application proxy with a listing of the mobile applications available on the nomadic device.

8. The system of claim 1, wherein the nomadic device is further configured to:
receive, by the mobile application via the connection, a second HMI status indicating a second level of HMI access of the mobile application to the HMI of the VCS; and
interact, by the mobile application, with the HMI in accordance with the second HMI status.

9. A system comprising:
a vehicle-based computing system (VCS) configured to
receive a registration of a proxy listener of a mobile from a nomadic device application proxy;
send an HMI status to the proxy listener indicative of a level of mobile application HMI access to be provided to the mobile application; and
present a mobile application user interface, via a VCS human-machine interface (HMI), in accordance with the HMI status.

10. The system of claim 9, wherein the VCS is further configured to send the HMI status responsive to the mobile application being moved into a foreground of the HMI of the VCS, and wherein the HMI status indicates that the mobile application is given full access to the HMI.

11. The system of claim 10, wherein the HMI status is configured to cause the nomadic device to perform user interface initialization with the VCS when the mobile application determines that the mobile application has not previously received an HMI status of full access to the HMI.

12. The system of claim 9, wherein the VCS is further configured to send the HMI status via a connection to the proxy listener of the mobile application managed by the application proxy.

13. The system of claim 12, wherein the HMI status is received by the proxy listener responsive to user selection of the mobile application from a mobile applications menu of the VCS.

14. The system of claim 12, wherein the VCS is further configured to send a notification via a proxy closed callback of the proxy listener indicating to the mobile application that the application proxy is disconnected from the VCS to cause the mobile application to un-initialize use of the application proxy.

15. The system of claim 9, wherein the nomadic device is further configured to:
instantiate the application proxy as a background process of the nomadic device;
receive, from the VCS by the application proxy, a query for mobile applications available on the nomadic device; and
respond to the VCS by the application proxy with a listing of the mobile applications available on the nomadic device.

16. The system of claim 9, wherein the VCS is further configured to:
send, to the mobile application, a second HMI status indicating a second level of HMI access of the mobile application to the HMI of the VCS; and
update presentation of the mobile application user interface in accordance with the second HMI status.

17. A non-transitory computer-readable medium including instructions that, when executed by a processor of a nomadic device, are configured to cause the nomadic device to:
register a mobile application with a vehicle-based computing system (VCS) using an application proxy configured to manage nomadic device connection to the VCS; and
utilize the application proxy, by the mobile application, to present a mobile application user interface, via a human-machine interface (HMI) of the VCS, according to an HMI status received from the VCS and indicative of a level of mobile application HMI access.

18. The medium of claim 17, further including instructions configured to cause the nomadic device to:
receive the HMI status, from the VCS by the application proxy, via the connection, to a proxy listener of the mobile application, responsive to the mobile application being moved into a foreground of the HMI of the VCS, wherein the HMI status indicates that the mobile application is given full access to the HMI; and
perform user interface initialization with the VCS when the mobile application determines that the mobile application has not previously received an HMI status of full access to the HMI.

19. The medium of claim 17, further including instructions configured to cause the nomadic device to:
instantiate the application proxy as a background process of the nomadic device;
receive, from the VCS by the application proxy, a query for mobile applications available on the nomadic device; and
respond to the VCS by the application proxy with a listing of the mobile applications available on the nomadic device.

20. The medium of claim 17, further including instructions configured to cause the nomadic device to:
receive, by the mobile application via the connection, a second HMI status indicating a second level of HMI access of the mobile application to the HMI of the VCS; and
interact, by the mobile application, with the HMI in accordance with the second HMI status.
